(19) United States
(12) Patent Application Publication
(10) Pub. No.: US 2021/0025615 A1
(43) Pub. Date: Jan. 28, 2021

(54) COMMUNICATIONS INTERFACE FOR HVAC COMPONENTS

(71) Applicant: Carrier Corporation, Palm Beach Gardens, FL (US)

(72) Inventor: Keith David Heigl, Winamac, IN (US)

(21) Appl. No.: 16/938,224

(22) Filed: Jul. 24, 2020

Related U.S. Application Data
(60) Provisional application No. 62/878,851, filed on Jul. 26, 2019.

(51) Int. Cl. F24F 11/56; F24F 11/63; H04L 29/08; H02M 7/06

(52) U.S. Cl. CPC F24F 11/56; F24F 11/63; F24F 2110/10; H02M 7/06; H04L 67/125

(57) ABSTRACT

A component of an HVAC system includes a controller; a communications module in communication with the controller, the communications module including: a modulator/demodulator configured to encode and decode data in a modulated waveform on a communications interface.

### CROSS-REFERENCE TO RELATED APPLICATIONS

This application claims the benefit of U.S. Provisional Patent Application Ser. No. 62/878,851 filed Jul. 26, 2019, the entire contents of which are incorporated herein by reference.

### BACKGROUND

The subject matter disclosed herein generally relates to communications interfaces and, more particularly, to a communications interface for use between heating, ventilation, and air conditioning (HVAC) components.

HVAC components often need to communicate, for example, to provide control of the HVAC system. Existing HVAC systems employ a two-wire interface to provide communication and power between HVAC components. An example two-wire interface is described in U.S. Pat. No. 6,956,463, the contents of which are incorporated herein by reference. While well suited for its intended purpose, existing two-wire interfaces may not enable modern communications operations, such as over-the-air reprogramming or program updates. These operations require high amounts of data, making such operations a very slow process using existing techniques.

### SUMMARY

According to an embodiment, a component of an HVAC system includes a controller; a communications module in communication with the controller, the communications module including: a modulator/demodulator configured to encode and decode data in a modulated waveform on a communications interface.

In addition to one or more of the features described herein, or as an alternative, further embodiments may include wherein the communications module comprises a zero-cross detector to detect a negative half cycle time of an AC waveform on the communications interface.

In addition to one or more of the features described herein, or as an alternative, further embodiments may include wherein the modulator/demodulator is configured to encode and decode the modulated waveform on the communications interface during the negative half cycle time of the AC waveform on the communications interface.

In addition to one or more of the features described herein, or as an alternative, further embodiments may include wherein the communications module comprises a transceiver configured to send data to the modulator/demodulator and receive data from the modulator/demodulator.

In addition to one or more of the features described herein, or as an alternative, further embodiments may include wherein the transceiver is configured to communicate with the controller.

In addition to one or more of the features described herein, or as an alternative, further embodiments may include wherein the modulated waveform includes a single carrier signal.

In addition to one or more of the features described herein, or as an alternative, further embodiments may include wherein the modulated waveform includes a plurality of carrier signals.

In addition to one or more of the features described herein, or as an alternative, further embodiments may include wherein the modulated waveform is centered about a DC offset.

In addition to one or more of the features described herein, or as an alternative, further embodiments may include wherein the component comprises a thermostat.

According to another embodiment, an HVAC system includes a first component; a second component; a communications interface providing communications between the first component and the second component; the first component comprising a communications module, the communications module including: a modulator/demodulator configured to encode and decode data in a modulated waveform on the communications interface.

In addition to one or more of the features described herein, or as an alternative, further embodiments of the system may include wherein the communications module comprises a zero-cross detector to detect the negative half cycle time of an AC waveform on the communications interface.

In addition to one or more of the features described herein, or as an alternative, further embodiments of the system may include wherein the modulator/demodulator is configured to encode and decode the modulated waveform on the communications interface during the negative half cycle time of the AC waveform on the communications interface.

In addition to one or more of the features described herein, or as an alternative, further embodiments of the system may include wherein the communications module comprises a transceiver configured to send data to the modulator/demodulator and receive data from the modulator/demodulator.

In addition to one or more of the features described herein, or as an alternative, further embodiments of the system may include wherein the transceiver is configured to communicate with a controller of the first component.

In addition to one or more of the features described herein, or as an alternative, further embodiments of the system may include wherein the modulated waveform includes a single carrier signal.

In addition to one or more of the features described herein, or as an alternative, further embodiments of the system may include wherein the modulated waveform includes a plurality of carrier signals.

In addition to one or more of the features described herein, or as an alternative, further embodiments of the system may include wherein the modulated waveform is centered about a DC offset.

According to another embodiment, a method of transferring data over a two-wire interface includes obtaining the data; detecting a negative half cycle time of an AC waveform on a communications interface; encoding the data on a carrier signal to produce a modulated waveform; transmitting the modulated waveform during the negative half cycle time of the AC waveform on the communications interface.

Technical effects of embodiments of the present disclosure include the ability to provide improved communications between components of an HVAC system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts two HVAC components in communication over a communications interface in an example embodiment;

FIG. 2 depicts a communications module in an example embodiment;

FIG. 3 depicts a communications waveform in an example embodiment.

### DETAILED DESCRIPTION

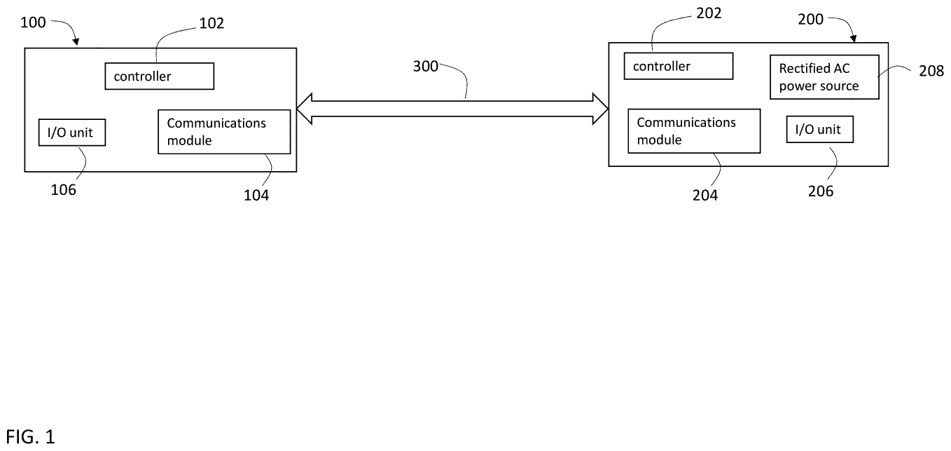

FIG. 1 depicts two HVAC components in communication over a communications interface in an example embodiment. A first component 100 includes a controller 102, a communications module 104 and an I/O unit 106. In an example embodiment, the first component 100 is a thermostat of an HVAC system. The controller 102 may include a processor (not shown) and an associated memory (not shown). The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be, but is not limited to, a random access memory (RAM), read only memory (ROM), or other electronic, optical, magnetic or any other computer readable medium. The memory may store executable instructions, that when executed by the processor, cause the controller 102 to perform operations described herein.

The communications module 104 provides enhanced communications between the first component 100 and a second component 200, as described herein. Although FIG. 1 depicts only two components, it is understood that the communications techniques described herein may apply to more than two components. The I/O unit 106 may include one or more of a keyboard or keypad, a touchscreen or touch panel, a display screen, a microphone, a speaker, a mouse, a button, a remote control, a joystick, a printer, a telephone or mobile device (e.g., a smartphone), a sensor, video, etc. The I/O unit 106 may be configured to provide an interface to allow a user to interact with the first component 100. For example, the I/O unit 106 may support a graphical user interface (GUI) and/or voice-to-text capabilities.

The first component 100 is in communication with a second component 200 over the communications interface 300. In an example embodiment, the second component 200 is a furnace, air handler, air conditioner, etc., of the HVAC system. The second component 200 includes a controller 202, a communications module 204 and an I/O unit 206. The controller 202, the communications module 204 and the I/O unit 206 may be implemented in the same manner as the controller 102, the communications module 104 and the I/O unit 106. The second component 200 also includes a rectified AC power source 208. Power is supplied during the positive half cycle time of the AC waveform. During the negative half cycle time, power is suppressed, providing time for data communications. For example, in a 60 Hz (16.6 mS cycle) system power can be drawn for about 8.3 mS. The next 8.3 mS time period, the negative half cycle is suppressed and data can be inserted. This repeats at the 16.6 mS rate. The communications interface 300 may be a two-wire interface, which is commonly used in legacy HVAC systems.

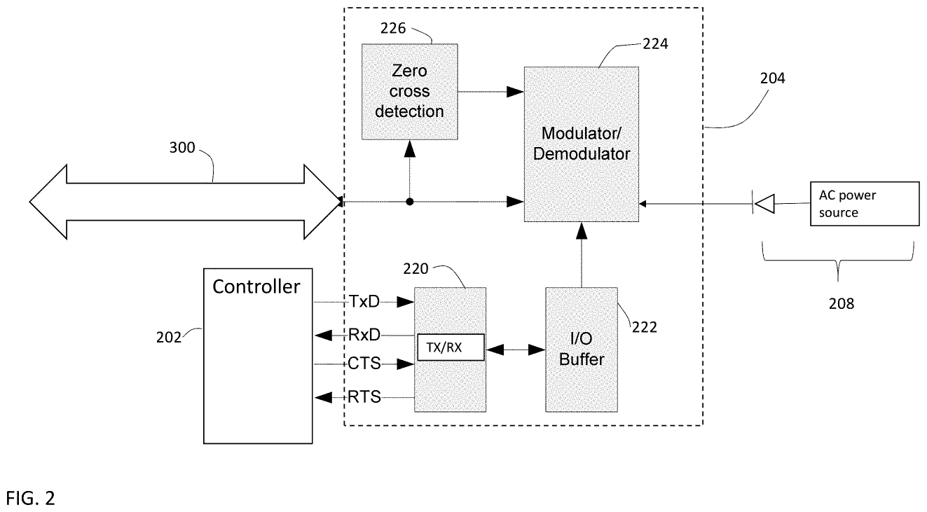

FIG. 2 depicts the communications module 204 in an example embodiment. The communications module 104 is configured in a similar manner, but does not require the rectified AC power source 208. The communications module 204 communicates with the communications module 104 over the communications interface 300. Also shown in FIG. 2 is the controller 202, communications interface 300 and the rectified AC power source 208, which may be implemented using an AC power source and a diode. The communications module 204 provides bidirectional communications between the second component 200 and the first component 100. The communications module 204 includes a transceiver 220 that communicates with the controller 202. The transceiver 220 may be implemented using a Universal Asynchronous Receiver/Transmitter (UART). A buffer 222 is coupled to the transceiver 220 to store the data for transmission/reception. A modulator/demodulator 224 encodes/decodes a modulated signal on a carrier signal communicated over the communications interface 300. A zero-cross detector 226 detects the negative half cycle time of the AC waveform typically suppressed on the communications interface 300 (e.g., a 24 volt AC waveform used in two-wire interfaces).

Operation of the communication module 104 is described with reference to data being transferred from the second component 200 to the first component 100. It is understood that communication module 102 will operate in a similar fashion. The controller 202 sends data destined to the first component 100 to the transceiver 220. From the transceiver 220, the data is supplied to the buffer 222 to be held until transmission on the communications interface 300 is available. In operation, the communication module 204 sends and receives data during the suppressed negative half cycle time of the AC waveform present on the communications interface 300. The negative half cycle time of the AC waveform on the communications interface 300 is detected by the zero-cross detector 226. When negative half cycle time of the AC waveform on the communications interface 300 occurs, the modulator/demodulator 224 encodes the data onto a carrier signal of a modulated waveform on the communications interface 300. The carrier signal is a signal different than the AC waveform from the AC power source 208. Other embodiments may use a non-rectified AC power source. In these embodiments, the negative half cycle time of the AC waveform is blocked and replaced with data on a carrier signal of a modulated waveform.

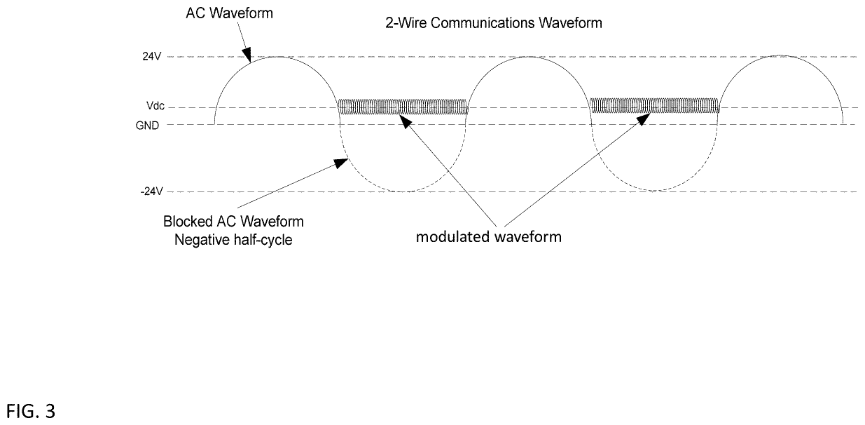

FIG. 3 depicts a signal on the communications interface 300. As shown in FIG. 3, the negative half cycle time of the AC waveform is suppressed. During the negative half cycle time of the AC waveform, a modulated waveform having a carrier signal modulated by the data is transmitted. The modulated waveform may be centered about a DC offset, shown as Vdc. The modulated waveform may be generated using known modulation schemes, such as S-FSK or OFDM, which may use a single carrier signal or multiple carrier signals.

Reception of data at the communications module 204 operates in the inverse manner. The zero-cross detector 226 detects the time that the negative half cycle of the AC waveform is suppressed on the communications interface 300. At this point, the modulator/demodulator 224 detects if a carrier signal is present. If so, the modulator/demodulator 224 demodulates the data present on the carrier signal. The data is provided to the buffer 222 and then to transceiver 220 for supply to the controller 202.

Embodiments allow for much higher data bandwidth transfers while minimizing the effects of reflections and other noise interference. Embodiments allow for higher volume data transfers, such as is needed for over-the-air program updates and data collection for equipment controls.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations. Further, one of ordinary skill in the art will appreciate that the steps described in conjunction with the illustrative figures may be performed in other than the recited order, and that one or more steps illustrated may be optional.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A component of an HVAC system, the component comprising:
a controller;
a communications module in communication with the controller, the communications module including:
a modulator/demodulator configured to encode and decode data in a modulated waveform on a communications interface.

2. The component of claim 1, wherein:
the communications module comprises a zero-cross detector to detect a negative half cycle time of an AC waveform on the communications interface.

3. The component of claim 2, wherein:
the modulator/demodulator is configured to encode and decode the modulated waveform on the communications interface during the negative half cycle time of the AC waveform on the communications interface.

4. The component of claim 1, wherein:
the communications module comprises a transceiver configured to send data to the modulator/demodulator and receive data from the modulator/demodulator.

5. The component of claim 4, wherein:
the transceiver is configured to communicate with the controller.

6. The component of claim 1, wherein:
the modulated waveform includes a single carrier signal.

7. The component of claim 1, wherein:
the modulated waveform includes a plurality of carrier signals.

8. The component of claim 1, wherein:
the modulated waveform is centered about a DC offset.

9. The component of claim 1, wherein:
the component comprises a thermostat.

10. An HVAC system comprising:
a first component;
a second component;
a communications interface providing communications between the first component and the second component;
the first component comprising a communications module, the communications module including:
a modulator/demodulator configured to encode and decode data in a modulated waveform on the communications interface.

11. The HVAC system of claim 10, wherein:
the communications module comprises a zero-cross detector to detect the negative half cycle time of an AC waveform on the communications interface.

12. The HVAC system of claim 11, wherein:
the modulator/demodulator is configured to encode and decode the modulated waveform on the communications interface during the negative half cycle time of the AC waveform on the communications interface.

13. The HVAC system of claim 10, wherein:
the communications module comprises a transceiver configured to send data to the modulator/demodulator and receive data from the modulator/demodulator.

14. The HVAC system of claim 13, wherein:
the transceiver is configured to communicate with a controller of the first component.

15. The HVAC system of claim 10, wherein:
the modulated waveform includes a single carrier signal.

16. The HVAC system of claim 10, wherein:
the modulated waveform includes a plurality of carrier signals.

17. The HVAC system of claim 10, wherein:
the modulated waveform is centered about a DC offset.

18. A method of transferring data over a two-wire interface, the method comprising:
obtaining the data;
detecting a negative half cycle time of an AC waveform on a communications interface;
encoding the data on a carrier signal to produce a modulated waveform;
transmitting the modulated waveform during the negative half cycle time of the AC waveform on the communications interface.
